(19) United States
(12) Patent Application Publication
(10) Pub. No.: US 2026/0012522 A1
(43) Pub. Date: Jan. 8, 2026

(54) METHOD OF COMPRESSING STATIC CONTEXT HEADER FOR IPV6 PACKETS BASED ON OPTICAL WIRELESS TECHNOLOGY AND DEVICE FOR PERFORMING THE SAME

(71) Applicant: Electronics and Telecommunications Research Institute, Daejeon (KR)

(72) Inventor: Younghwan CHOI, Daejeon (KR)

(73) Assignee: Electronics and Telecommunications Research Institute, Daejeon (KR)

(21) Appl. No.: 19/256,279

(22) Filed: Jul. 1, 2025

(30) Foreign Application Priority Data
Jul. 2, 2024 (KR) 10-2024-0087143
Oct. 18, 2024 (KR) 10-2024-0142948
Feb. 28, 2025 (KR) 10-2025-0026818
Jun. 16, 2025 (KR) 10-2025-0078889

(51) Int. Cl. H04L 69/324; H04B 10/116; H04L 9/06

(52) U.S. Cl. CPC H04L 69/324; H04B 10/116; H04L 9/0643

(57) ABSTRACT

A method of compressing a static context header for an Internet Protocol version 6 (IPv6) packet based on an optical wireless technology, and a device for performing the same are provided. A method of transmitting an IPv6 packet based on an optical wireless communication (OWC) technology in an OWC device includes transmitting a Router Solicitation (RS) packet, receiving an IPv6 packet through an OWC link layer, and transmitting the IPv6 packet through an adaptation layer for IPv6 over OWC. An interface identifier (IID) included in an IPv6 link local address of the OWC device may be constructed using an algorithm that generates a random identifier (RID). The RS packet may include a predetermined bit notifying that Static Context Header Compression and Fragmentation (SCHC) for header compression is supported.

### CROSS-REFERENCE TO RELATED APPLICATIONS

This application claims the benefit of Korean Patent Application No. 10-2024-0087143, filed on Jul. 2, 2024, Korean Patent Application No. 10-2024-0142948, filed on Oct. 18, 2024, Korean Patent Application No. 10-2025-0026818, filed on Feb. 28, 2025, and Korean Patent Application No. 10-2025-0078889, filed on Jun. 16, 2025, in the Korean Intellectual Property Office, the entire disclosures of which are incorporated herein by reference for all purposes.

### BACKGROUND

### 1. Field of the Invention

One or more embodiments relate to a method of compressing a static context header for an Internet Protocol version 6 (IPv6) packet based on a shot-range optical wireless technology, and a device for performing the same.

### 2. Description of the Related Art

The rapid growth of the Internet of Things (IoT) has led to a significant increase in the number of wireless communication technologies utilized for real-time data collection and monitoring in various industrial domains, for example, manufacturing, agriculture, healthcare, or transportation. Such a trend highlights the importance of wireless communication in facilitating real-time data exchange and analysis, ultimately enhancing operational efficiency and decision-making processes in various industrial sectors.

There is a communication standard for Internet Protocol version 6 (IPv6) packet transmission for Internet communication based on the existing Institute of Electrical and Electronics Engineers (IEEE) 802.15.4 low-power sensor network. However, for communication between heterogeneous objects based on various wireless technologies in the future, it is difficult to apply the above communication standard as a standard and an algorithm for a transmission of IPv6 packets based on other wireless technologies (e.g., Bluetooth, infrared, etc.).

The above description is information the inventor(s) acquired during the course of conceiving the present disclosure, or already possessed at the time, and is not necessarily art publicly known before the present application was filed.

### SUMMARY

One or more embodiments provide a method to transmit an Internet Protocol version 6 (IPv6) packet over a shot-range optical wireless communication (OWC), for example, a method of compressing a packet header such as an IPv6 header using Static Context Header Compression and Fragmentation (SCHC).

One or more embodiments transmit a signal indicating that SCHC is supported.

However, the technical aspects are not limited to the aforementioned aspects, and other technical aspects may be present.

According to an aspect, there is provided a method of transmitting an IPv6 packet based on an OWC technology in an OWC device, the method including transmitting a Router Solicitation (RS) packet, receiving an IPv6 packet through an OWC link layer, and transmitting the IPv6 packet through an adaptation layer for IPv6 over OWC, wherein an interface identifier (IID) included in an IPv6 link local address of the OWC device is constructed using an algorithm that generates a random identifier (RID), and the RS packet includes a predetermined bit notifying that Static Context Header Compression and Fragmentation (SCHC) for header compression is supported.

The predetermined bit may be set in an option field of an IPv6 over low-power wireless personal area network (6LoWPAN) Capability Indication Option (6CIO).

The predetermined bit may be the last bit in a 6LoWPAN capability bits registry.

The RS packet may be a 6LoWPAN-Neighbor Discovery (ND) RS packet.

The algorithm may include an F( ) algorithm.

The F( ) algorithm may use SHA-256.

An input parameter of the F( ) algorithm may include at least one of a Net_Iface parameter or a Network_ID parameter.

The Net_Iface parameter may use an OWC link layer address.

The OWC link layer address may be a 16-bit link layer address.

The Network_ID parameter may use an OWC link layer address.

According to another aspect, there is provided an OWC device including at least one processor, and memory storing instructions, wherein the instructions, when individually or collectively executed by the at least one processor, cause the OWC device to transmit an RS packet, receive an IPv6 packet through an OWC link layer, and transmit the IPv6 packet through an adaptation layer for IPv6 over OWC, wherein an IID included in an IPv6 link local address of the OWC device is constructed using an algorithm that generates a RID, and the RS packet includes a predetermined bit notifying that SCHC for header compression is supported.

The predetermined bit may be set in an option field of a 6LoWPAN 6CIO.

The predetermined bit may be the last bit in a 6LoWPAN capability bits registry.

The RS packet may be a 6LoWPAN-ND RS packet.

The algorithm may include an F( ) algorithm.

The F( ) algorithm may use SHA-256.

An input parameter of the F( ) algorithm may include at least one of a Net_Iface parameter or a Network_ID parameter.

The Net_Iface parameter may use an OWC link layer address.

The OWC link layer address may be a 16-bit link layer address.

The Network_ID parameter may use an OWC link layer address.

According to embodiments, a method of selectively performing a 6LoWPAN compression technique in parallel with an SCHC compression technique may be provided. Accordingly, the embodiments may efficiently select a transmission method (i.e., a compression technique) according to the characteristics of data.

According to embodiments, security against an external attack, such as a sniffing attack, may increase in various applications by selectively performing a plurality of compression techniques in parallel in an optical wireless communication environment such as light-emitting diodes (LEDs).

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an optical wireless communication (OWC) according to an embodiment;

FIGS. 2 to 8 are diagrams illustrating a method of transmitting an Internet Protocol version 6 (IPv6) packet over OWC according to an embodiment; and

FIG. 9 is a block diagram schematically illustrating a communication device according to an embodiment.

### DETAILED DESCRIPTION

The following structural or functional descriptions of embodiments described herein are merely intended for the purpose of describing the embodiments described herein and may be implemented in various forms. Here, the embodiments are not construed as limited to the disclosure and should be understood to include all changes, equivalents, and replacements within the idea and the technical scope of the disclosure.

Although terms of “first”, “second”, and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” to another component, it may be understood that the one component is directly connected or accessed to another component or that still other component is interposed between the two components.

The singular forms “a,” “an,” and “the” are intended to include the plural forms as well, unless the context clearly indicates otherwise. As used herein, “A or B,” “at least one of A and B,” “at least one of A or B,” “A, B or C,” “at least one of A, B, and C,” and “A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

As used in connection with the present disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

As used herein, the term “unit” (or “-er/or”) refers to software or hardware components such as a field-programmable gate array (FPGA) or an ASIC, and the unit may perform some functions. However, the unit is not limited to software or hardware. The unit may be configured to be on an addressable storage medium or may be configured to operate one or more processors. For example, the unit may include components, such as software components, object-oriented software components, class components, task components, processes, functions, attributes, procedures, subroutines, segments of program code, drivers, firmware, microcode, circuits, data, databases, data structures, tables, arrays, and variables. The functionality provided within components and units may be combined into fewer components and units or further separated into additional components and units. In addition, the components and units may also be implemented to operate one or more central processing units (CPUs) in a device or security multimedia card. Furthermore, the unit may include one or more processors.

Hereinafter, embodiments will be described in detail with reference to the accompanying drawings. When describing the embodiments with reference to the accompanying drawings, like reference numerals refer to like components, and a repeated description related thereto is omitted.

In the present specification, terms may be defined below.

Internet Protocol version 6 (IPv6) over low-power wireless personal area network (6LoWPAN) Node (6LN):

A 6LoWPAN node may be any host or router participating in a LoWPAN.

6LoWPAN Router (6LR):

A 6LoWPAN router may be an intermediate router in a LoWPAN that may send and receive Router Advertisements (RAs) and Router Solicitations (RSs), as well as forward and route IPv6 packets.

6LoWPAN Border Router (6LBR):

A 6LoWPAN border router may be a border router located at a junction of separate 6LoWPAN networks or between a 6LoWPAN network and another IP network. One or more 6LBRs may be present at a 6LoWPAN network boundary. The 6LBR may be a responsible authority for IPv6 prefix propagation for a 6LoWPAN that provides services. An isolated LoWPAN may also include a 6LBR in a network that provides a prefix for the isolated network.

Duplicate Address Detection (DAD).

DAD may be a mechanism used to prevent an address conflict by ensuring that two devices do not share the same address in an Internet Protocol version 6 (IPv6) network.

Static Context Header Compression and Fragmentation (SCHC).

SCHC may be a general framework.

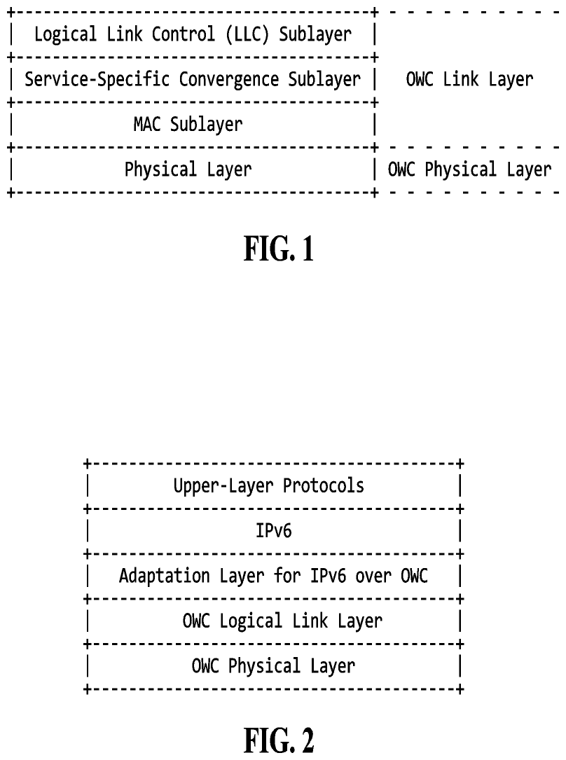

FIG. 1 is a diagram illustrating an optical wireless communication (OWC) according to an embodiment. FIG. 1 illustrates a protocol stack of the OWC.

The OWC may utilize an intensity modulation of optical sources, for example, light-emitting diodes (LEDs) and laser diodes (LDs), to transmit data at a speed higher than a speed at which human eyes may perceive. The OWC may combine lighting and data communications, to find out applications in various domains including area lighting, signboards, streetlights, vehicles, traffic signals, displays, LED panels, and digital signage.

### Network Topology

A media access control (MAC) layer of the OWC may provide three types of topologies, for example, a peer-to-peer (P2P) topology, a star topology, and a broadcast topology. In the star topology, communication may be established between devices and a single central controller, called a coordinator. In the P2P topology, one of two devices in an association may function as a coordinator. More complex topologies, such as a mesh topology, may be supported using P2P at a higher layer with IPv6 over OWC.

### Protocol Stack of OWC

A protocol stack of the OWC may include a plurality of layers (e.g., an OWC physical layer PHY, and an OWC link layer). The OWC link layer may include a plurality of sublayers (e.g., a MAC sublayer, a service-specific convergence sublayer (SSCS), and a logical link control (LLC) sublayer).

The physical layer PHY in the OWC may include a light transceiver and low-level control mechanisms associated with the light transceiver. The physical layer PHY may handle a transmission and reception of light signals, encoding and decoding of data, and managing of physical characteristics of a communication channel. On top of the physical layer PHY, a MAC sublayer that facilitates an access to a physical channel for various types of data transmissions may be present. The MAC sublayer may control a method by which a device shares a medium, manage an access protocol, and ensure fair and efficient utilization of an OWC channel. The physical layer PHY and the MAC sublayer may form a data link layer in the OWC, to enable a transmission and reception of data over a physical medium.

In the protocol stack of the OWC, an upper layer may include a network layer (not shown) responsible for network configuration, manipulation, and message routing, and an application layer (not shown) that encompasses an intended functionality of a device. To access the MAC sublayer, the LLC sublayer may utilize the SSCS. The LLC sublayer may provide a bridge between an upper layer (e.g., the network layer, and the application layer) and the MAC sublayer, to facilitate a transmission of data and control information between the two layers. Upper layers, including the network layer and application layer, may operate in conjunction with the MAC sublayer and utilize the LLC sublayer and the SSCS to enable efficient communication and functionality within an OWC system.

To transmit an IPv6 packet over OWC, a packet may need to be passed to the LLC sublayer. For IPv6 addressing or address configuration, the LLC sublayer may provide related information, such as a link-layer address, to an upper layer.

### Addressing of OWC Device

An OWC device may have a unique 64-bit address. When a device is connected to a coordinator node, a short 16-bit address may be allocated. One of two addresses may be used for communication within an OWC data link network. Therefore, a 16-bit address and a 64-bit address may be used to generate an IPv6 interface identifier (IID).

Table 1 shows an MTU and a data rate of an OWC link layer. In Table 1, the maximum packet size provided by an OWC parameter “aMaxPHYFrame-Size,” and data rates that may be supported for each OWC physical layer type, as specified in the Institute of Electrical and Electronics Engineers (IEEE) 802.15.7 standard, are summarized.

TABLE 1

| Type | MTU | Data Rates |
|---|---|---|
| PHY1 | 1,023 bytes | 11.67 kbps~266.6 kbps |
| PHY2 | 65,535 bytes | 1.25 Mbps~96 Mbps |
| PHY3 | 65,535 bytes | 12 Mbps~96 Mbps |

FIGS. 2 to 8 are diagrams illustrating a method of transmitting an IPv6 packet over OWC according to an embodiment. Hereinafter, a method of transmitting an IPv6 packet over OWC according to an embodiment is described with reference to FIGS. 2 to 8. Short-range optical wireless communication may include wireless communication using visible light. In an embodiment, technology of transmitting an IPv6 packet over the short-range optical wireless communication using IPv6 based on a low-power wireless personal area network (e.g., a 6LoWPAN) may be provided.

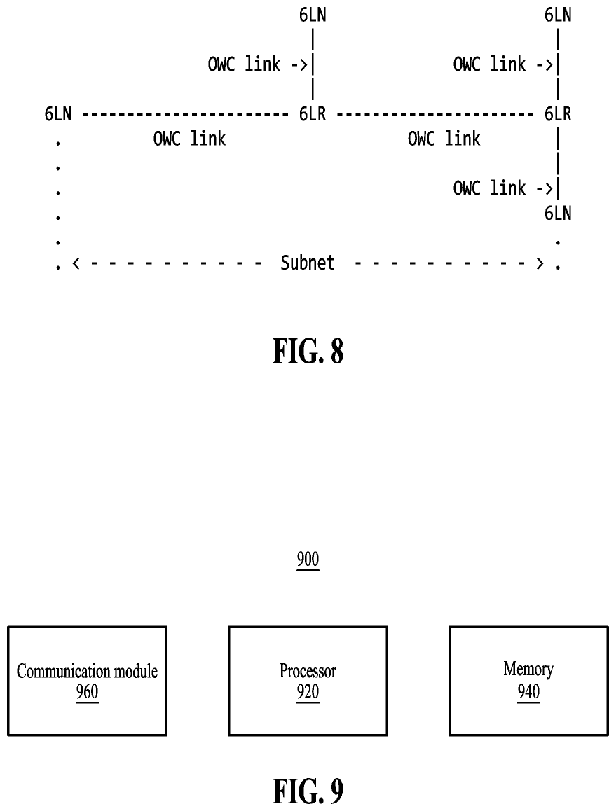

FIG. 2 illustrates an IPv6-over-OWC protocol stack. A communication device, for example, an OWC device (or an OWC support device) may transmit and/or receive IPv6 packets over OWC. The OWC device (e.g., a communication device 800 of FIG. 8) may use a 6LoWPAN to transmit and/or receive an IPv6 packet over OWC. OWC technology may have requirements owing to low power consumption and allowed protocol overhead, and the 6LoWPAN may provide a useful functionality for reducing overhead of IPv6 over OWC. For example, a functionality provided by the 6LoWPAN may include link-local IPv6 addresses and stateless IPv6 address autoconfiguration, neighbor discovery, header compression, and fragmentation, and may be used to transmit and/or receive an IPv6 packet over OWC.

### Protocol Stack

Upper-layer protocols may be transport-layer protocols (e.g., TCP and UDP), application-layer protocols, and other protocols that may be executed on top of IPv6. The OWC device may receive an IPv6 packet through the OWC link layer and transmit an IPv6 packet through an adaptation layer for IPv6 over OWC.

The adaptation layer for IPv6 over OWC may be a protocol layer required to transmit and receive an IPv6 datagram (e.g., a packet) generated by an IPv6 protocol through a lower layer. The adaptation layer for IPv6 over OWC may support neighbor discovery, stateless IPv6 address autoconfiguration, header compression, and fragmentation and reassembly, based on the 6LoWPAN. A 6LoWPAN header compression (e.g., refer to RFC6282) may not define header compression for a TCP. The latter may still be supported by IPv6 over OWC, albeit without the performance optimization of header compression.

### Stateless Address Autoconfiguration

The OWC device may perform a stateless address autoconfiguration. For example, the OWC device may perform the stateless address autoconfiguration according to RFC4862. An IID (e.g., a 64-bit IID) for an OWC interface may be formed by utilizing the 16-bit address or 64-bit address. In the viewpoint of address configuration, the IID may guarantee a stable IPv6 address during a single connection process because each data link connection is uniquely identified by an OWC data link layer. In accordance with the guidance of RFC7136, IIDs of all unicast addresses for the OWC device may have a length of 64 bits and may be constructed based on a random identifier (RID). For example, the IID may be constructed using an algorithm that generates a RID (e.g., refer to RFC7217).

The RID may be an output generated by an F( ) algorithm with input parameters. One of the input parameters may be a Net_Iface parameter, and an OWC 16-bit link layer address may be a source of the Net_Iface parameter. A 16-bit address may easily be targeted by attacks (e.g., address scanning) from a third party. The F( ) algorithm with SHA-256 may provide secured and stable IIDs for the OWC device. In addition, an optional parameter, Network_ID, may be used to increase a randomness of a generated IID with the OWC link layer address. A secret key may need to be at least 128 bits. It may be initialized to a pseudorandom number (e.g., refer to RFC4086).

### IPv6 Link Local Address

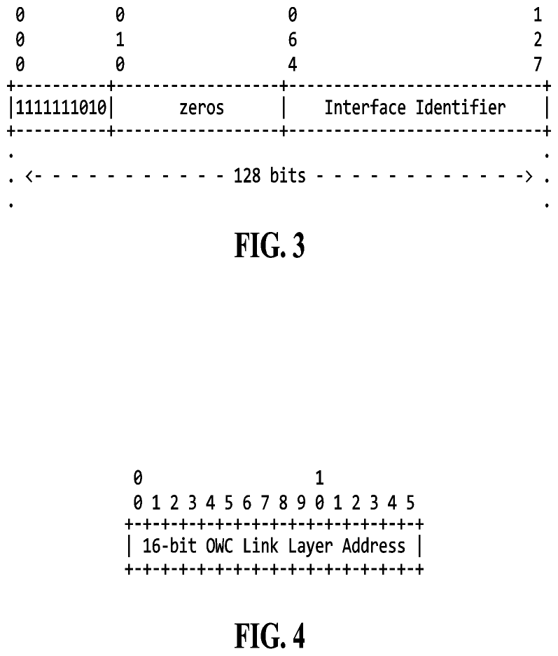

FIG. 3 illustrates an IPv6 link-local address of an OWC device. The IPv6 link-local address of the OWC device may be formed by appending an IID to a prefix fe80::/64, as illustrated in FIG. 3.

### Neighbor Discovery

A neighbor discovery optimization for a 6LoWPAN (e.g., refer to RFC6775 and RFC8505) describes a neighbor discovery approach in several 6LoWPAN topologies, such as mesh topologies. IPv6 over OWC may support mesh topologies with route-over.

(1) When an OWC 6LN is directly connected to a 6LBR, a 6LN may register its address with the 6LBR by sending neighbor solicitation (NS) (e.g., an NS message) with an Extended Address Registration Option (EARO) (e.g., refer to RFC8505). When the 6LN and 6LBR are linked to each other, the 6LBR may assign an address to the 6LN. In the above process, a duplicate address detection (DAD) (e.g., refer to RFC6775) may not be required.

(2) When two or more multi-hop topologies by OWC 6LNs are connected to the 6LBR, the 6LBR may perform a DAD for an acquired link local address of the 6LN. In such a topology, a 6LN having two or more links with neighbor nodes may function as a router.

(3) To receive RSs and RAs, the OWC 6LN may need to follow Sections 5.3 and 5.4 of RFC6775.

(4) When the OWC device is a 6LR or a 6LBR, the OWC device may need to follow Sections 6 and 7 of RFC6775.

### Header Compression

FIG. 4 is a diagram illustrating an example of header compression used in an OWC network. FIG. 4 may illustrate an OWC short address format. Header compression as defined in RFC6282, which specifies a compression format for IPv6 datagrams on top of IEEE 802.15.4, may be needed as the basis for IPv6 header compression on top of OWC. All headers may be compressed according to encoding formats described in RFC6282. In RFC6282, IPv6 header compression may be implemented. In addition, implementations may also support Generic Header Compression (GHC) as described in RFC7400. If a 16-bit address is required as a short address, it may be formed by a 16-bit OWC link layer address, as illustrated in FIG. 4.

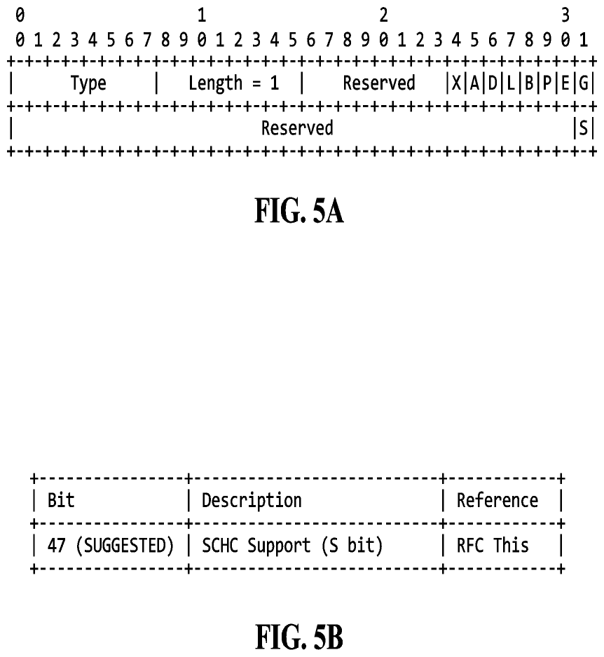

FIGS. 5A and 5B are diagrams illustrating another example of header compression used in an OWC network.

A node (e.g., an OWC device) may perform SCHC to reduce overhead. For example, an OWC device may selectively use SCHC while using header compression, as described with reference to FIG. 4. The OWC device may utilize a mechanism for a header compressed by SCHC if an SCHC-compressed header is required. For example, the SCHC may be used to compress an IPv6 header, an IPv6/user datagram protocol (UDP) header, IPv6/UDP/constrained application protocol (CoAP) (e.g., when a CoAP is used), or the like. The node (e.g., an OWC device) may notify that SCHC for header compression is supported.

In the star topology, the node (e.g., an OWC device) may use (e.g., transmit) a 6LoWPAN Capability Indication Option (6CIO) to notify that SCHC for header compression is supported. The 6CIO may include an option field in which a predetermined bit (e.g., an “S” bit) is set to notify that SCHC for header compression is supported. The predetermined bit (e.g., an “S” bit) is a 1-bit flag and may be the last bit (e.g., a 47-th bit) in the “6LoWPAN capability bits” registry.

The node (e.g., an OWC device) may transmit a 6LoWPAN-Neighbor Discovery (ND) Router Solicitation (RS) packet including the 6CIO in which the predetermined bit is set. Thereafter, a 6LoWPAN-ND RA that the node (e.g., an OWC device) receives may implicitly indicate whether SCHC is supported because SCHC is already available.

In the multi-hop topology, when the entire 6LoWPAN network is administratively required to support SCHC-compressed packet transmission, the node (e.g., an OWC device) may use SCHC header compression. In this case, all network nodes (e.g., including an OWC device) may support at least one of the route-over modes. For example, the route-over mode may include Straightforward Route-Over (SRO), Tunneled, RPL-based Route-Over (TRO), or Pointer-based Route-Over (PRO). Additionally, all network nodes may use the same route-over mode at the predetermined time point.

Frame formats used to transmit the SCHC-compressed IPv6 packet over OWC may vary depending on the network topology (e.g., a star topology or a multi-hop topology). In the case of a multi-hop topology, the frame format may be determined according to the route-over mode used. In the case of an IPv6 over OWC, the “IEEE 802.15.4 frame payload” may be replaced with the “IEEE 802.15.7 frame payload.”

### Fragmentation and Reassembly (FAR)

For a physical layer PHY1 of OWC, IPv6 over OWC may use a FAR defined in RFC4944. An MTU of the physical layer PHY1 of the OWC may be less than an MTU (1280 bytes) of an IPv6 packet. Since an MTU of a physical layer PHY2 and an MTU of a physical layer PHY3 in the OWC are greater than the MTU of the IPv6 packet, IPv6 over OWC may use the FAR defined in RFC4944 at an adaptation layer for payloads as described above. Even though MTUs (e.g., the physical layers PHY2 and PHY3) of the OWC device are greater than 1280 octets, a 1280-octet MTU may be used so that a path MTU discovery procedure (e.g., refer to RFC7668) may not be required. However, for communication between the OWC device and other non-OWC devices on the Internet, the MTU may be 1280 bytes (e.g., for a device on the Internet) and the path MTU discovery procedure may be needed.

### Unicast and Multicast Address Mapping

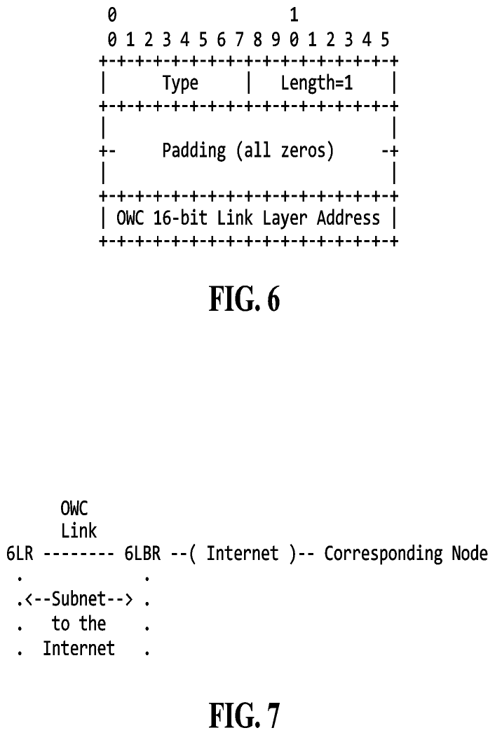

FIG. 6 illustrates a link layer address option format for a unicast address mapping. An address resolution procedure for mapping an IPv6 non-multicast address into an OWC link layer address may follow a general description in Sections 4.6.1 and 7.2 of RFC4861, unless otherwise specified.

A source/target link-layer address option may have a form shown below when an address is a 16-bit OWC link layer address.

Option fields are shown below.

### Type:

1: Source Link-Layer Address
2: Target Link-Layer Address

### Length:

A Length field may be a length of an option (including Type and Length fields) in units of 8 bits. A value of the Length field may be “1” for the 16-bit OWC link layer address.

An OWC link layer may not support multicast. Packets may be always transmitted by unicast between two OWC devices. For example, even when a 6LBR is connected to multiple 6LNs, it may be impossible for the 6LBR to multicast to all the connected 6LNs. When the 6LBR needs to send a multicast packet to all 6LNs, the 6LBR may need to replicate the packet and unicast the packet on each link. However, since this is not energy-efficient, a central node, which is battery-powered, may need to take particular care of power consumption. To further conserve power, the 6LBR may keep track of multicast listeners at an OWC link-level granularity (not at subnet granularity), and forward a multicast packet to a 6LN that is not registered as a listener for a multicast group the packet belongs to. In the opposite direction, a 6LN may always send packets to the 6LBR or through the 6LBR. When a 6LN needs to transmit an IPv6 multicast packet, the 6LN may unicast a corresponding OWC packet to the 6LBR.

### Internet Connectivity Scenarios.

The OWC device network may operate in the following two forms.

### Single-Hop Network.

The single-hop network may be suitable for a small-scale Internet of Things (IoT) application, such as small-scale smart home automation, in which the OWC device (e.g., an OWC-supporting device) communicates directly.

### Multi-Hop Network.

The multi-hop network may be suitable for a case in which the OWC device transmits data across multi-hop to expand a network range (e.g., an industrial IoT deployment). Interoperability with other 610 wireless technologies may also be considered. In the hybrid network, IPv6 over OWC may coexist with these technologies by utilizing an IPv6 routing mechanism and may support smooth integration with existing infrastructure.

FIG. 7 illustrates an example of an OWC device network connected to the Internet.

Other OWC devices may be executed as 6LNs and 6LRs and may communicate with a 6LBR, as long as both the 6LNs and 6LRs are within their ranges.

A 6LBR may function as a router and forward packets between a 6LN and the Internet. In addition, the 6LBR may need to prevent an occurrence of an address collision because the 6LN is connected to the 6LBR, similarly to a start topology, and the 6LBR may determine whether an IPv6 address is duplicated because the 6LN may need to register an address of the 6LN with the 6LBR.

FIG. 8 illustrates an example of an OWC device multi-hop network.

As illustrated in FIG. 8, an OWC device network may permanently operate as a simple and isolated ad-hoc network. Two groups including 6LNs may be interconnected with a star topology, and each group may be connected to the 6LR.

In a multi-hop topology (e.g., a more complex topology), a DAD may require an extension for a multi-hop network, such as the ones in RFC6775.

FIG. 9 is a block diagram schematically illustrating a communication device according to an embodiment.

Referring to FIG. 9, according to an embodiment, the communication device 900 (e.g., the OWC device or the OWC-supporting device of FIGS. 1 to 8) may include a processor 920, a memory 940, and a communication module 960.

The memory 940 may store instructions (or programs) executable by the processor 920. The instructions may include, for example, instructions for executing operations of the processor 920 and/or instructions for executing operations of each component of the processor 920.

The memory 940 may include one or more computer-readable storage media. The memory 940 may include non-volatile storage devices, for example, a magnetic hard disc, an optical disc, a floppy disc, a flash memory, an erasable programmable read-only memory (EPROM), and an electrically erasable programmable read-only memory (EEPROM).

The memory 940 may be non-transitory media. The term “non-transitory” may indicate that a storage medium is not embodied in a carrier wave or a propagated signal. However, the term “non-transitory” should not be interpreted that the memory 940 is non-movable.

The processor 920 may process data stored in the memory 940. The processor 920 may execute computer-readable code (e.g., software) stored in the memory 940 and instructions caused by the processor 920.

The processor 920 may be a hardware-implemented data processing device having a physically structured circuit for executing desired operations. The desired operations may include, for example, code or instructions included in a program.

The hardware-implemented data processing device may include, for example, a microprocessor, a CPU, a processor core, a multi-core processor, a multiprocessor, an ASIC, or an FPGA.

The processor 920 may cause the communication device 900 to perform one or more operations by executing code, instructions, and/or applications stored in the memory 940. The operations performed by the communication device 900 may be substantially the same as the operations performed by the OWC device described above with reference to FIGS. 1 to 8, and accordingly, further description thereof is not repeated herein.

The communication module 960 may establish a communication channel (e.g., a wireless communication channel) for communications. The communication module 960 may support performing communications over the established communication channel. The communication module 960 may include one or more communication processors that support direct (e.g., wired) or wireless communication. The communication module 960 may include a wireless communication module (e.g., a cellular communication module, a short-range wireless communication module, or a global navigation satellite system (GNSS) communication module) or a wired communication module (e.g., a local area network (LAN) communication module or a power line communication module).

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer-readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard discs, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While the embodiments are described with reference to the drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of transmitting an Internet Protocol version 6 (IPv6) packet based on an optical wireless communication (OWC) technology in an OWC device, the method comprising:
transmitting a Router Solicitation (RS) packet;
receiving an IPv6 packet through an OWC link layer; and
transmitting the IPv6 packet through an adaptation layer for IPv6 over OWC,
wherein an interface identifier (IID) included in an IPv6 link local address of the OWC device is constructed using an algorithm that generates a random identifier (RID), and
wherein the RS packet comprises a predetermined bit notifying that Static Context Header Compression and Fragmentation (SCHC) for header compression is supported.

2. The method of claim 1, wherein the predetermined bit is set in an option field of an IPv6 over low-power wireless personal area network (6LoWPAN) Capability Indication Option (6CIO).

3. The method of claim 1, wherein the predetermined bit is a last bit in an IPv6 over low-power wireless personal area network (6LoWPAN) capability bits registry.

4. The method of claim 1, wherein the RS packet is an IPv6 over low-power wireless personal area network (6LoWPAN)-Neighbor Discovery (ND) RS packet.

5. The method of claim 1, wherein the algorithm comprises an F( ) algorithm.

6. The method of claim 5, wherein the F( ) algorithm uses SHA-256.

7. The method of claim 5, wherein an input parameter of the F( ) algorithm comprises at least one of a Net_Iface parameter or a Network_ID parameter.

8. The method of claim 7, wherein the Net_Iface parameter uses an OWC link layer address.

9. The OWC-based IPv6 packet transmission method of claim 8, wherein the OWC link layer address is a 16 bit.

10. The OWC-based IPv6 packet transmission method of claim 7, wherein the Network_ID parameter uses an OWC link layer address.

11. An optical wireless communication (OWC) device, comprising:
at least one processor; and
memory storing instructions,
wherein the instructions, when individually or collectively executed by the at least one processor, cause the OWC device to:
transmit a Router Solicitation (RS) packet;
receive an IPv6 packet through an OWC link layer; and
transmit the IPv6 packet through an adaptation layer for IPv6 over OWC,
wherein an interface identifier (IID) included in an IPv6 link local address of the OWC device is constructed using an algorithm that generates a random identifier (RID), and
wherein the RS packet comprises a predetermined bit notifying that Static Context Header Compression and Fragmentation (SCHC) for header compression is supported.

12. The OWC device of claim 11, wherein the predetermined bit is set in an option field of an IPv6 over low-power wireless personal area network (6LoWPAN) Capability Indication Option (6CIO).

13. The OWC device of claim 11, wherein the predetermined bit is a last bit in an IPv6 over low-power wireless personal area network (6LoWPAN) capability bits registry.

14. The OWC device of claim 11, wherein the RS packet is an IPv6 over low-power wireless personal area network (6LoWPAN)-Neighbor Discovery (ND) RS packet.

15. The OWC device of claim 11, wherein the algorithm comprises an F( ) algorithm.

16. The OWC device of claim 15, wherein the F( ) algorithm uses SHA-256.

17. The OWC device of claim 15, wherein an input parameter of the F( ) algorithm comprises at least one of a Net_Iface parameter or a Network_ID parameter.

18. The OWC device of claim 17, wherein the Net_Iface parameter uses an OWC link layer address.

19. The OWC device of claim 18, wherein the OWC link layer address is a 16-bit.

20. The OWC device of claim 17, wherein the Network_ID parameter uses an OWC link layer address.
